(19) United States
(12) Patent Application Publication
(10) Pub. No.: US 2013/0192119 A1
(43) Pub. Date: Aug. 1, 2013

(54) System and Method for Placing Game Attractant into a Hunting Area

(71) Applicant: Charles Joseph Zimmerman, Alexander City, AL (US)

(72) Inventor: Charles Joseph Zimmerman, Alexander City, AL (US)

(21) Appl. No.: 13/736,918

(22) Filed: Jan. 8, 2013

Related U.S. Application Data
(60) Provisional application No. 61/593,011, filed on Jan. 31, 2012.

(51) Int. Cl. A01M 31/00

(52) U.S. Cl. CPC A01M 31/008
USPC 43/2; 124/17

(57) ABSTRACT

A system and method for placing game attractant in a hunting area includes a projectile containing game attractant and a launcher for launching the projectile into the hunting area. The projectile may include a wicking material containing game attractant and the method may include the steps of soaking the projectile in game attractant, loading the projectile into the launcher, and launching the projectile into the hunting area.

### CROSS-REFERENCE TO RELATED APPLICATIONS

The present application is a nonprovisional patent application of U.S. provisional patent application Ser. No. 61/593,011, filed on Jan. 31, 2012 and entitled “Scent Shotz.” The '011 application is hereby incorporated by reference into the present application.

### BACKGROUND OF THE INVENTION

The present invention relates generally to a system and method for placing game attractant into a hunting area. More specifically, the present invention pertains to a system and method for placing game attractant into a hunting area without contaminating or disturbing the hunting area.

Hunters typically place game attractant in a hunting area in order to attract desired game to the area and they typically do so by physically walking into the area to distribute the attractant. This process, however, may contaminate the area with the hunter's scent. Accordingly, there is a need for a way to distribute game attractant in a hunting area that does not suffer from this disadvantage.

### SUMMARY OF THE INVENTION

The present invention is directed toward a system and method that can be used to place game attractant into a hunting area. In one embodiment, the system includes at least one projectile containing game attractant and a launcher for launching the projectile into a hunting area. In another embodiment, the method includes the steps of soaking a projectile in game attractant, loading the projectile into a launcher, and launching the projectile into the hunting area using the launcher.

### BRIEF DESCRIPTION OF THE DRAWINGS

FIG. 1 is a side view of one embodiment of a projectile used with the present invention separated into two pieces.

FIG. 2 is a side view of the embodiment shown in FIG. 1 with each piece of the projectile filled with wicking material.

FIG. 3 is a side view showing a bottle containing game attractant and the two pieces of the projectile shown in FIG. 2 filled with game attractant.

FIG. 4 is a side view of the projectile shown in FIG. 1 with the two pieces snapped back together.

FIG. 5 is a side view of a second embodiment of a projectile used with the present invention.

FIG. 6 is a side view of the third embodiment of a projectile used with the present invention.

FIG. 7 is a side view showing one embodiment of the launcher used with the present invention.

FIG. 8 is a side view showing a fourth embodiment of a projectile used with the present invention.

FIG. 9 is a second side view of the embodiment shown in FIG. 8 showing the opposite side of the projectile.

### DETAILED DESCRIPTION OF THE INVENTION

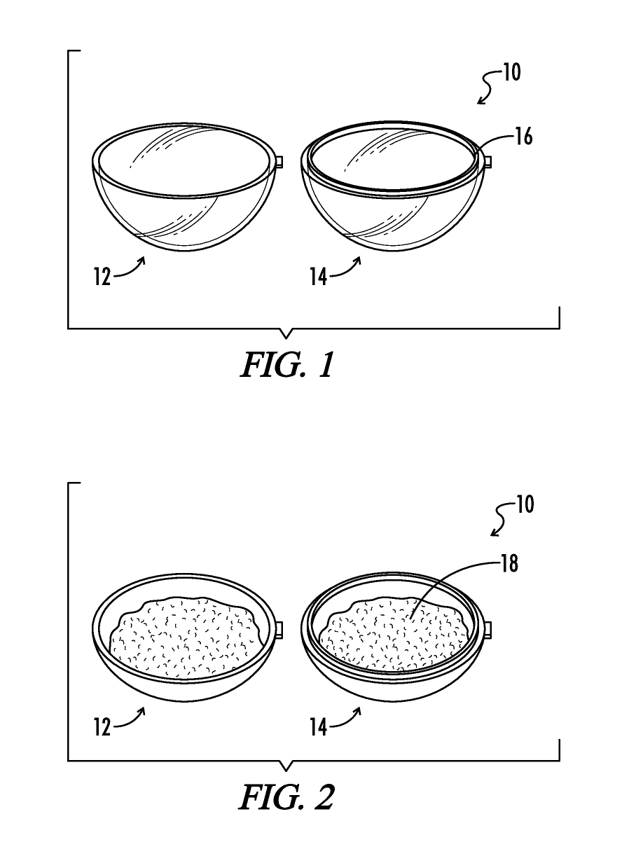

One embodiment of a projectile, sphere-shaped projectile 10, used with the present invention is shown in FIG. 1. This embodiment includes two substantially similar pieces, 12 and 14, that can be snapped together to form sphere-shaped projectile 10. Piece 14 includes a lip 16 that facilitates snapping the two pieces, 12 and 14, together. Although the embodiment shown in FIG. 1 is made out of hard plastic, other embodiments may be made out of pulp products, such as wood, lead, metal, composites, rubber, vinyl, glass, soft plastic, or similar materials. This embodiment also has a ½ inch diameter but other embodiments may have larger or smaller diameters and may have completely different shapes.

As shown in FIG. 2, projectile 10 is filled with a wicking material 18, which is used to absorb game attractant placed inside the projectile 10. Wicking material 18 may be sawdust, as shown in FIG. 1, or any other material that will absorb liquid or gel, such as cotton, compressed cotton, cloth, dirt, clay, a pulp product, or a cotton/rayon rope.

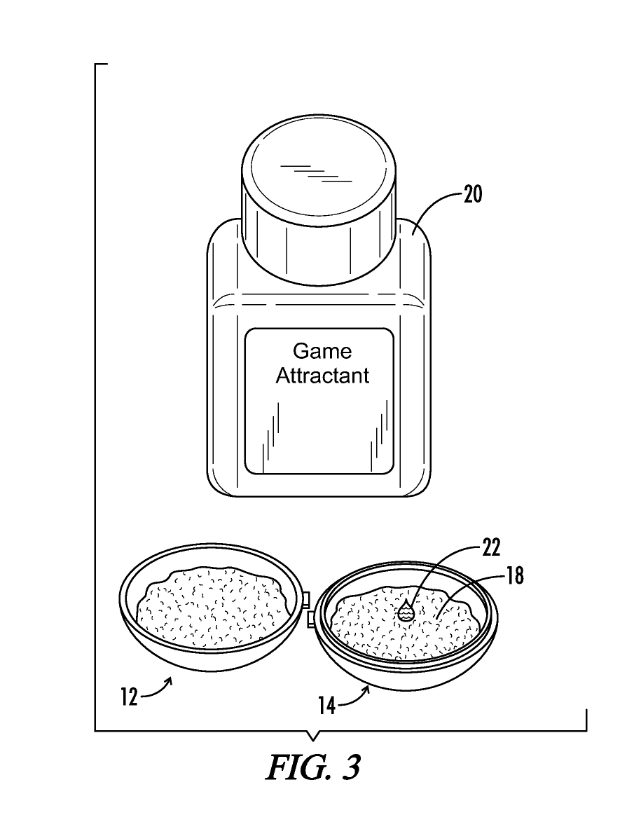

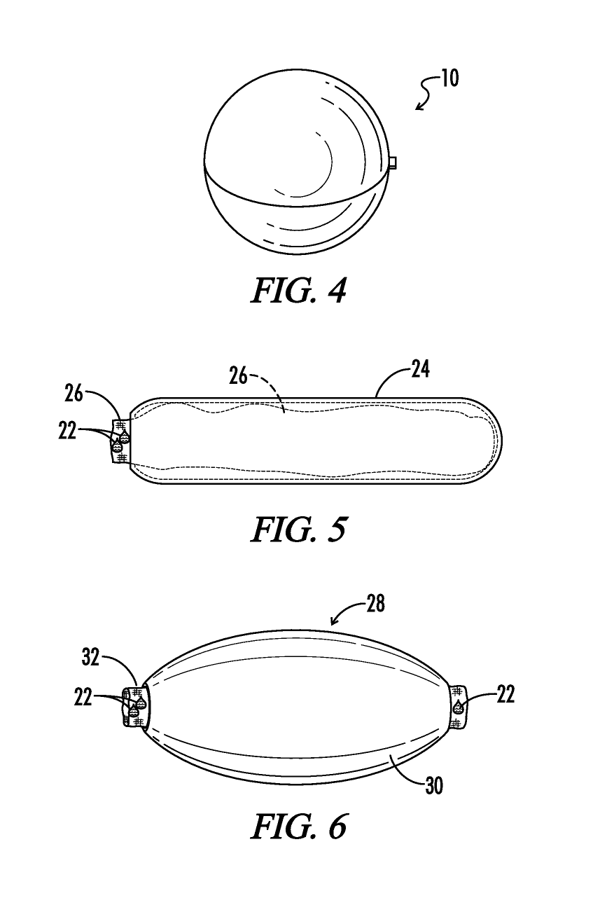

FIG. 3 shows a bottle of game attractant 20 and the two pieces, 12 and 14, filed with wicking material 18 and game attractant 22. The amount of game attractant can vary from as little as one drop to more than several drops. Although a liquid game attractant is shown in FIG. 3, other types of game attractant, such as gels, may be used as well. Game attractant 22 may be deer, elk, bear, hog, or predator attractant. FIG. 4 shows projectile 10 snapped back together with wicking material 18 and game attractant 22 included inside.

Another embodiment of a projectile, projectile 24, used with the present invention is shown in FIG. 5. This embodiment is made out of soft plastic and includes a cotton wicking material 26. A portion of the wicking material extends outward from the soft plastic projectile body of the projectile 24 and game attractant is applied by placing one or more drops on the exposed portion of the wicking material and allowing it to be absorbed.

A third embodiment of a projectile, projectile 28, is shown in FIG. 6. This embodiment includes a lead weight projectile body 30 and compressed cotton wicking material 32 disposed within an opening defined in the body 30 and extending outward from the body 30 in opposite directions. Once again, game attractant is applied by placing one or more drops on the exposed portions of the wicking material and waiting for the game attractant to be absorbed by the wicking material.

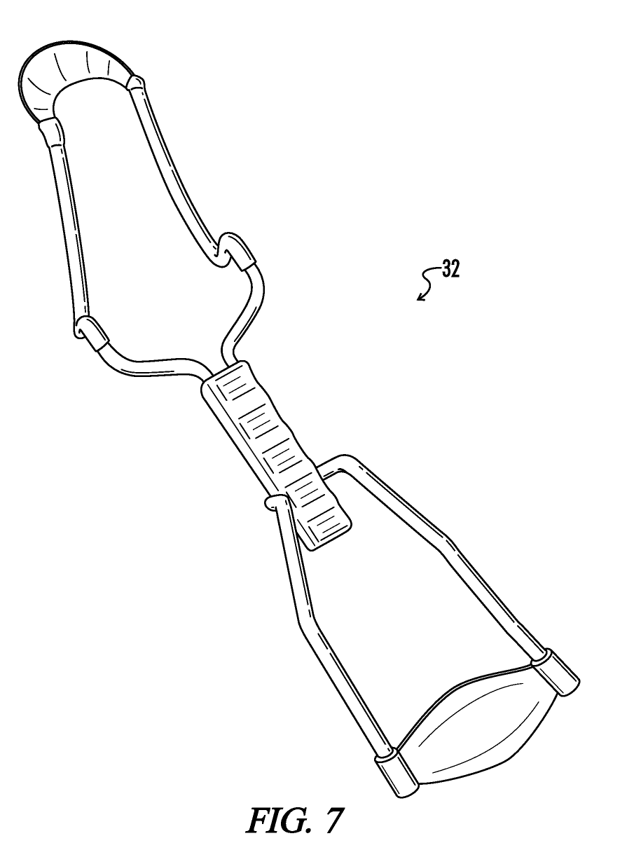

One embodiment of a launcher, launcher 32, used with the present invention is shown in FIG. 7. This embodiment is a conventional slingshot made by Daisy. In other embodiments, various other types of launchers may be used, such as paint ball guns, carbon dioxide (CO2) guns, bows, and other similar devices.

The launcher 32 is used to launch projectiles like projectiles 10, 24, and 28 into a hunting area. As a result, hunters do not have to physically walk into that area in order to place game attractant and risk contaminating the area with their scent or otherwise disturbing the area. In certain situations, projectiles may simply be tossed, thrown, dropped or placed in a strategic spot in a hunting area for easy retrieval.

Projectile 10, shown in FIGS. 1-4, will burst upon impact when launched by launcher 32 and release game attractant soaked wicking material in the hunting area. Projectile 24 and 28 include wicking material that is exposed to air so the game attractant scent is released automatically when these embodiments are used.

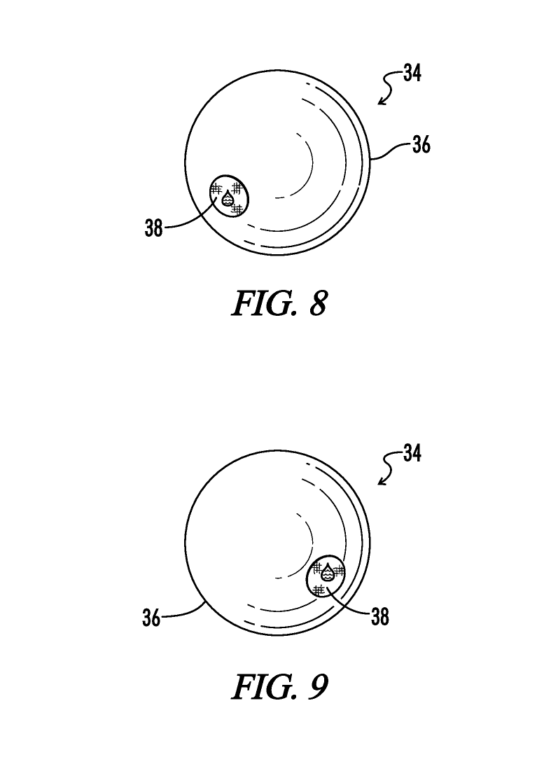

A fourth embodiment of a projectile, projectile 34, is shown in FIGS. 8 and 9. This embodiment includes a biodegradable wooden projectile body 36 having an opening defined therein. Wicking material 38, in this case a cotton/rayon rope, is disposed in the opening. The ends of the wicking material are flush (portions of the wicking material may extend outward from the body 36 in some embodiments and from opposite sides of the body 36 in others) with the ends of the opening in this embodiment. This embodiment can be soaked in game attractant by placing one or more drops on the exposed ends of the wicking material or by placing one or more drops of game attractant in a container, such as an ice tray or egg carton, placing the projectile 34 in the container and game attractant, and waiting for the game attractant to be absorbed by the wicking material.

In order to reduce human scent on the projectiles, scent eliminating wipes may be used to wipe the projectiles before they are launched into the hunting area.

The above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

What is claimed is:

1. A method for placing game attractant in a hunting area, comprising:
soaking a projectile in game attractant;
loading the projectile in a launcher; and
launching the projectile into the hunting area using the launcher.

2. The method of claim 1, wherein the step of soaking the projectile includes the steps of opening the projectile, placing at least one drop of game attractant inside the projectile, and closing the projectile.

3. The method of claim 1, wherein the projectile includes a wicking material and the wicking material absorbs a portion of the game attractant when the projectile is soaked in the game attractant.

4. The method of claim 3, wherein the wicking material is sawdust, cotton, compressed cotton, cloth, dirt, clay, a pulp product, or a cotton/rayon rope.

5. The method of claim 4, wherein the projectile includes a projectile body made out of hard plastic, soft plastic, lead, metal, composite, rubber, vinyl, glass, or wood.

6. The method of claim 5, wherein the projectile body is transparent, semi-transparent, orange, green, or white and spherical, cylindrical, or oval in shape.

7. The method of claim 6, wherein the launcher is a slingshot, paint ball gun, carbon dioxide gun, or bow.

8. The method of claim 7, wherein the game attractant is deer, elk, beer, hog, or predator attractant.

9. The method of claim 1, wherein the step of soaking the projectile includes the steps of placing at least one drop of game attractant into a container, placing the projectile into the container and the game attractant, and waiting for the game attractant to be absorbed by wicking material included in the projectile.

10. A system for placing game attractant in a hunting area, comprising:
a projectile containing game attractant.

11. The system of claim 10, wherein the projectile includes a projectile body made out of hard plastic, soft plastic, lead, metal, composite, rubber, vinyl, glass, or wood.

12. The system of claim 11, wherein the projectile body is spherical, cylindrical, or oval in shape.

13. The system of claim 12, wherein the projectile includes a wicking material containing game attractant.

14. The system of claim 13, wherein the wicking material is disposed within a cavity defined in the projectile body.

15. The system of claim 14, wherein a portion of the wicking material extends outward from the projectile body or the wicking material is completely enclosed by the projectile body.

16. The system of claim 15, wherein the wicking material is cotton, compressed cotton, cloth, dirt, clay, a pulp product, sawdust or a cotton/rayon rope.

17. The system of claim 16, wherein the projectile body is transparent, semi-transparent, orange, green, or white.

18. The system of claim 17, further comprising a launcher for launching the projectile into the hunting area.

19. The system of claim 18, wherein the launcher is a slingshot, paint ball gun, carbon dioxide gun, or bow.

20. The system of claim 19, wherein the game attractant is deer, elk, beer, hog, or predator attractant.
